(19) United States
(12) Patent Application Publication
(10) Pub. No.: US 2013/0002549 A1
(43) Pub. Date: Jan. 3, 2013

(54) REMOTE-CONTROL DEVICE AND CONTROL SYSTEM AND METHOD FOR CONTROLLING OPERATION OF SCREEN

(75) Inventors: Ching-Tsung Chen, Taipei City (TW); Tsang-Der Ni, Hsinchu City (TW); Kwang-Sing Tone, Hsinchu City (TW); Deng-Huei Hwang, New Taipei City (TW)

(73) Assignees: J-MEX, INC., Hsinchu City (TW); ASUSTEK COMPUTER INC., Taipei City (TW)

(21) Appl. No.: 13/540,069

(22) Filed: Jul. 2, 2012

(30) Foreign Application Priority Data
Jul. 1, 2011 (TW) 100123436

(51) Int. Cl. G06F 3/033

(52) U.S. Cl. 345/158

(57) ABSTRACT

A control system for controlling an operation of a screen having a first geometric reference includes a marking device and a remote-control device. The marking device displays a first pattern associated with the first geometric reference on the screen. The remote-control device obtains a signal from the screen. The signal represents an image having a second geometric reference and a second pattern associated with the first pattern. The second pattern and the second geometric reference have a first geometric relationship therebetween. The remote-control device uses the first geometric relationship to transform the second pattern into a third pattern, and calibrates the first geometric reference according to the third pattern for controlling the operation of the screen.

### CROSS-REFERENCES TO RELATED APPLICATIONS

This application claims the benefit of Taiwan Patent Application No. 100123436, filed on Jul. 1, 2011, in the Taiwan Intellectual Property Office, the disclosures of which are incorporated herein in their entirety by reference.

### FIELD OF THE INVENTION

The present invention relates to a remote-control device, and more particularly to a motion-sensing remote-control device and a control system and method for controlling an operation of a screen.

### BACKGROUND OF THE INVENTION

At present, on the platform of the personal computer (PC), each product of the three-dimensional (3D) air mouse devices, generally collocates with the communication interface unit and the driving program of the existing two-dimensional mouse device. The current on-plane mouse device controls the cursor to move by means of sensing the plane motion distance through a mechanical and/or optical means. The 3D air mouse device drives the cursor by means of sensing the 3D motion thereof generated by the hand motion. Therefore, except the different sensing means, the cursor operation characteristics of the 3D air mouse device is in itself still similar to those of the on-plane mouse device controlled through the PC, so that it is insufficient to give full scope to the motion-sensing operation features of the 3D air mouse device for causing the cursor control to be more convenient and more nimble. In contrast therewith, when the cursor moves to a boundary area of the display area of the screen, the abovementioned cursor control method causes the cursor on the boundary no longer moves to cross the boundary in response to the motion of the remote controller or the air mouse device, and causes a problem the pointing direction of the subsequent posture orientation of the remote controller or the air mouse is inconsistent with the cursor position, and thus further causes the operation perplexity that the user posture orientation cannot be aligned with the cursor.

Besides, on the game platform of the Nintendo Company, the Wii game device has a remote controller employing an image sensor to sense two light emitting diodes, so that the remote controller can be operated to correspond to a specific range of the screen for controlling the cursor movement on the specific range. However, the abovementioned disadvantage occurring on the PC platform still exists in the Wii game device; i.e. the orientation of the remote controller cannot keep being aligned with the cursor in operation. For instance, a technical scheme in the prior art disclosed in U.S. Patent Application Publication No. 2010/0292007 A1 provides systems and methods for a control device including a movement detector.

It is considered the condition that: a handheld motion-sensing remote controller is operated to select items of the electronic menu on the screen, or a 3D air mouse device is controlled to move a cursor and conduct a click for selecting an icon. Please refer to FIG. 1(a), FIG. 1(b) and FIG. 1(c), which are schematic diagrams showing a first operation, a second operation and a third operation of a motion remote-control system 10 in the prior art, respectively. As shown in FIG. 1(a), FIG. 1(b) and FIG. 1(c), the motion remote-control system 10 includes a remote-control device 11 and a screen 12. The screen 12 has a display area 121, which has a perimeter 1211; and a cursor H11 is displayed in the display area 121. The remote-control device 11 may be one of a motion-sensing remote controller and a 3D air mouse device.

For instance, as shown in FIG. 1(a), the cursor H11 is controlled to move in the horizontal direction. In a state E111, the remote-control device 11 has an orientation N111, and the orientation N111 with an alignment direction V111 is aligned with the cursor H11. In a state E112, the remote-control device 11 has an orientation N112, and the orientation N112 with an alignment direction V112 is aligned with the cursor H11. The posture or the orientation of the remote-control device 11 in the air points to a variable direction; and ideally, the variable direction is to be aligned with the cursor H11 moved on the screen, so that the user can intuitively consider being consistent with the direction, indicating where the cursor H11 is located, when operating the cursor movement by the gesture or the motion of its hand.

However, the first operation shown in FIG. 1(a) can form perplexity having existed for a long time. How the perplexity is formed is shown in FIG. 1(b). In a state E121, the remote-control device 11 has an orientation N121, and the orientation N121 with an alignment direction V121 is aligned with the cursor H11. In a state E122, the remote-control device 11 has an orientation N122, and the orientation N122 with an alignment direction V122 is aligned with a position P11 outside the display area 121. For instance, in the state E121, the cursor H11 touches a boundary of the perimeter 1211 of the display area 121. Afterward, if the remote-control device 11 further has a motion or a posture change, the orientation of the remote-control device 11 will only be changed from the orientation N121 into the orientation N122, and the pointing direction of the remote-control device 11 will be correspondingly changed from the alignment direction V121, originally pointing to the cursor H11, into the alignment direction V122, but the remote-control device 11 cannot cause the cursor H11 to further cross over the perimeter 1211.

Under this condition, the second operation shown in FIG. 1(b) will result in the phenomenon shown in FIG. 1(c). In a state E131, the remote-control device 11 has an orientation N131, and the orientation N131 with the alignment direction V131 is aligned with a position P12 outside the display area 121. When the remote-control device 11 is moved back to control the cursor H11 to simultaneously move back, the remote-control device 11 has the orientation N131, which is aligned with the position P12, and the pointing direction of the remote-control device 11 cannot be caused to point to the alignment direction V132 for being aligned with the cursor H11 in the display area 121. In this way, the remote-control device 11 cannot be recovered to have the orientation or the posture, which the remote-control device 11 previously has under the normal operation in the state that the cursor H11 has not touched the perimeter 1211, thereby forming an orientation deviation. The orientation deviation causes that the remote-control device 11 cannot have the alignment direction V132 to be aligned with the cursor H11 under the orientation N131 for intuitively controlling the motion of the cursor H11. Therefore, the inconsistence between the alignment direction of the orientation of the remote-control device 11 and the actual direction pointing to the cursor causes the perplexity when the user operates.

### SUMMARY OF THE INVENTION

It is therefore an object of the present invention to correct a sensing error, which is derived from an operation error between a remote-control device and a screen.

It is an embodiment of the present invention to provide a control system for controlling an operation of a screen having a first geometric reference. The control system includes a marking device and a remote-control device. The marking device displays a first pattern associated with the first geometric reference on the screen. The remote-control device obtains a signal from the screen. The signal represents an image having a second geometric reference and a second pattern associated with the first pattern. The second pattern and the second geometric reference have a first geometric relationship therebetween. The remote-control device uses the first geometric relationship to transform the second pattern into a third pattern, and calibrates the first geometric reference according to the third pattern for controlling the operation of the screen.

It is a further embodiment of the present invention to provide a control method for controlling an operation of a screen having a first geometric reference. The control method includes the following steps. A first pattern associated with the first geometric reference is displayed on the screen. A remote-control device is provided. A signal is obtained from the screen, wherein the signal represents an image having a second geometric reference and a second pattern associated with the first pattern, and the second pattern and the second geometric reference have a geometric relationship therebetween. The second pattern is transformed into a third pattern according to the geometric relationship. The first geometric reference is calibrated according to the third pattern for controlling the operation of the screen.

It is a further embodiment of the present invention to provide a control method for controlling an operation of a screen having a first geometric reference. The control method includes the following steps. A first pattern associated with the first geometric reference is displayed on the screen. A remote-control device is provided. A second pattern associated with the first pattern is generated, wherein the second pattern has a reference orientation. The second pattern is transformed according to the reference orientation to obtain a second geometric reference for calibrating the first geometric reference. The remote-control device is caused to control the operation of the screen based on the second geometric reference.

It is a further embodiment of the present invention to provide a control method for controlling an operation of a screen having a first geometric reference. The control method includes the following steps. A first pattern associated with the geometric reference is displayed on the screen. A remote-control device is provided. A second pattern associated with the first pattern is generated, wherein the second pattern has a reference orientation. The geometric reference is calibrated in the remote-control device according to the reference orientation for controlling the operation of the screen.

It is a further embodiment of the present invention to provide a remote-control device for controlling an operation of a screen having a geometric reference and a first pattern associated with the geometric reference. The remote-control device includes a pattern generator and a defining medium. The pattern generator generates a second pattern associated with the first pattern, wherein the second pattern has a reference orientation. The defining medium defines the geometric reference according to the reference orientation for controlling the operation of the screen.

### BRIEF DESCRIPTION OF THE DRAWINGS

The foregoing and other features and advantages of the present invention will be more clearly understood through the following descriptions with reference to the drawings, wherein:

FIG. 1(a), FIG. 1(b) and FIG. 1(c) are schematic diagrams showing a first operation, a second operation and a third operation of a motion remote-control system in the prior art, respectively;

FIG. 2 is a schematic diagram showing a control system according to the first embodiment of the present invention;

FIG. 3(a), FIG. 3(b) and FIG. 3(c) are schematic diagrams showing three configurations of a control system according to the second embodiment of the present invention, respectively; and

FIG. 4(a), FIG. 4(b) and FIG. 4(c) are schematic diagrams showing three pattern models of the control system according to the second embodiment of the present invention, respectively.

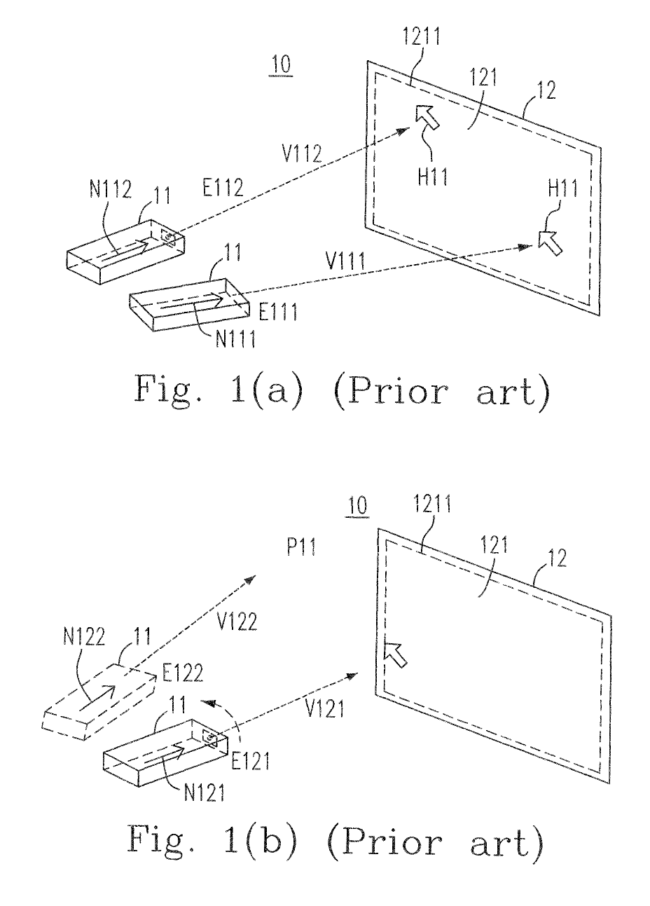

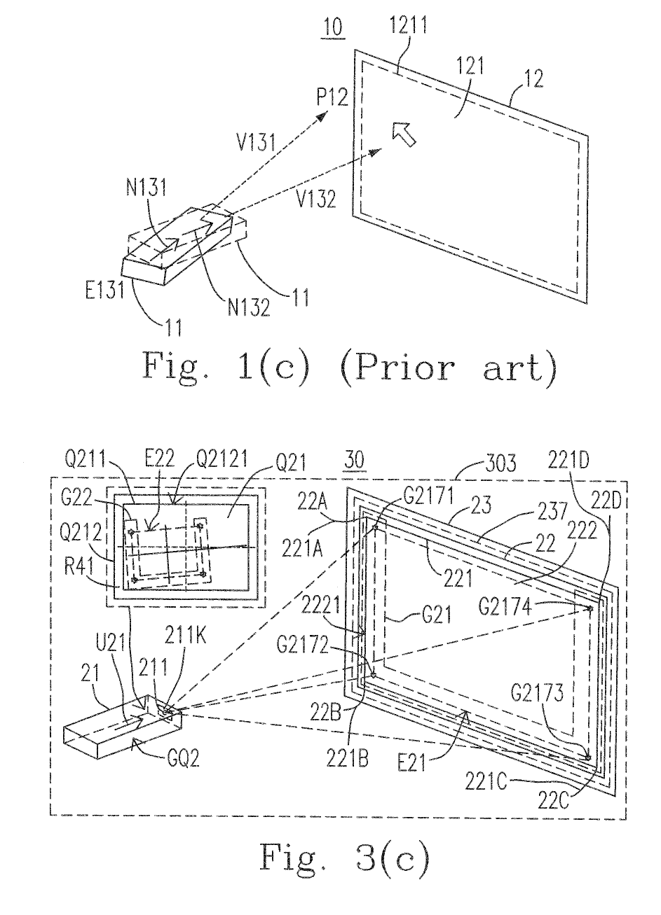

### DETAIL DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

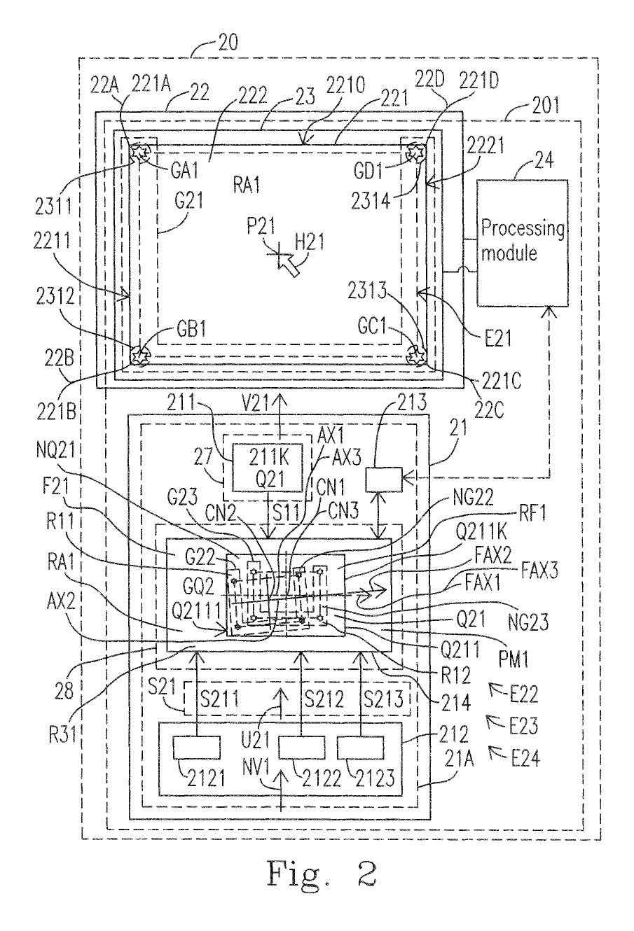

Please refer to FIG. 2, which is a schematic diagram showing a control system 20 according to the first embodiment of the present invention. As shown, the control system 20 includes a screen 22 and a control system 201 for controlling an operation B1 of the screen 22. In one embodiment, the screen 22 has a geometric reference 221. The control system 201 includes a marking device 23 and a remote-control device 21. The marking device 23 displays a pattern G21 associated with the geometric reference 221 on the screen 22. The remote-control device 21 obtains a signal S11 from the screen 22. The signal S11 represents an image Q21 having a geometric reference Q211 and a pattern G22 associated with the pattern G21. The pattern G22 and the geometric reference Q211 have a geometric relationship R11 therebetween. The remote-control device 21 uses the geometric relationship R11 to transform the pattern G22 into a pattern G23, and calibrates the geometric reference 221 according to the pattern G23 for controlling the operation B1 of the screen 22.

In one embodiment, the screen 22 further has an operation area 222. The operation area 222 is a display area or a matrix display area. For instance, the operation area 222 has a characteristic rectangle, which has an upper left corner point 22A, a lower left corner point 22B, a lower right corner point 22C and an upper right corner point 22D. The geometric reference 221 is configured to identify the operation area 222. For instance, the geometric reference 221 has a reference rectangle 2211; the reference rectangle 2211 has a reference area 2210 for identifying the operation area 222, and has four reference positions 221A, 221B, 221C and 221D; and the four reference positions 221A, 221B, 221C and 221D are located at the upper left corner point 22A, the lower left corner point 22B, the lower right corner point 22C and the upper right corner point 22D of the operation area 222, respectively. A shape of the geometric reference Q211 of the image Q21 corresponds to a shape of the geometric reference 221. For instance, the geometric reference Q211 has a characteristic rectangle Q2111. For instance, the geometric reference Q211 is fixed, and is configured to define a reference area of the image Q21.

For instance, the pattern G21 has a characteristic rectangle E21. For instance, the pattern G21 and the geometric reference 221 may have a geometric relationship RA1 therebetween, and the pattern G23 and the geometric reference Q211 have a geometric relationship R12 therebetween. The remote-control device 21 obtains the geometric relationship R11, and may transform the pattern G23 into a geometric reference GQ2 according to the geometric relationships RA1 and R12 for calibrating the geometric reference 221.

In one embodiment, the remote-control device 21 has an orientation NV1, which has a reference direction U21. The remote-control device 21 obtains the signal S11 from the screen 22 in the reference direction U21, and further obtains an estimated direction F21 for estimating the reference direction U21. For instance, the remote-control device 21 senses the pattern G21 to obtain the signal S11 in the reference direction U21, and further senses the reference direction U21 to obtain the estimated direction F21 of the remote-control device 21 in the reference direction U21. The geometric reference 221 may be configured to identify the operation area 222, which includes a predetermined position P21. The remote-control device 21 obtains the geometric reference GQ2 for calibrating the geometric reference 221 according to the geometric relationship R11, thereby correlating the reference direction U21 with the predetermined position P21. The estimated direction F21 may be configured to express the alignment direction V21 aligned with the predetermined position P21 in the reference direction U21. The estimated direction F21 may be a reference-estimated direction, and the predetermined position P21 may be a reference position. For instance, the operation area 222 has a cursor H21 located thereon; and the predetermined position P21 is located in the center portion of the operation area 222, and serves as a starting reference point of the cursor H21. The remote-control device 21 causes the cursor H21 to be located at the predetermined position P21 in the reference direction U21. In one embodiment, the remote-control device 21 correlates the reference direction U21 with the predetermined position P21 according to the geometric relationship R11 and the estimated direction F21.

In one embodiment, the geometric reference Q211 has a reference rectangle Q2111, which has a shape center CN1 and a shape principal axis AX1. The pattern G22 has a characteristic rectangle E22 corresponding to the characteristic rectangle E21, wherein the characteristic rectangle E22 has a shape center CN2 and a shape principal axis AX2. The pattern G23 has a characteristic rectangle E23 corresponding to the characteristic rectangle E21, wherein the characteristic rectangle E23 has a shape center CN3 and a shape principal axis AX3. The pattern G22 and the geometric reference Q211 have the geometric relationship R11 therebetween. The geometric relationship R11 includes a position relationship between the shape center CN1 and the shape center CN2, and a direction relationship between the shape principal axis AX1 and the shape principal axis AX2. For instance, each of the shape centers CN1, CN2 and CN3 is a respective geometric center, and each of the shape principal axis AX1 is a respective geometric principal axis.

The remote-control device 21 obtains a transformation parameter PM1 according to the geometric relationship R11, and transforms the pattern G22 into the pattern G23 according to the transformation parameter PM1, wherein the transformation parameter PM1 includes a displacement parameter associated with the position relationship, and a rotation parameter associated with the direction relationship. The pattern G23 and the geometric reference Q211 have the geometric relationship R12 therebetween. The geometric relationship R12 includes a first relationship and a second relationship, wherein the first relationship is that the shape center CN1 coincides with the shape center CN3, and the second relationship is that the shape principal axis AX1 is aligned with the shape principal axis AX3.

In one embodiment, the marking device 23 displays a digital content in the operation area 222 for displaying the pattern G21 by using a program. The pattern G21 may flicker at a specific frequency, and may also includes at least a light-emitting geometric pattern. For instance, the pattern G21 may be collocated with the digital content to flicker at the specific frequency for definitely distinguishing the pattern G21 from the external noise or the background light (the background noise). The screen 22 has the geometric reference 221 for the operation B1. The remote-control device 21 may control a change of the specific frequency according to a change of the operation B1.

In one embodiment, the pattern G21 includes four sub-patterns GA1, GB1, GC1 and GD1. The four sub-patterns GA1, GB1, GC1 and GD1 are four light-emitting marks or four light-emitting spots, respectively, and are distributed near the four corner points 22A, 22B, 22C and 22D of the operation area 222, respectively. In one embodiment, the marking device 23 includes four light-source devices 2311, 2312, 2313 and 2314. The four light-source devices 2311, 2312, 2313 and 2314 generate the sub-patterns GA1, GB1, GC1 and GD1, respectively.

In one embodiment, the operation area 222 has a first resolution. The geometric reference Q211 is configured to define an area Q211K, which has a second resolution provided by the image Q21. The remote-control device 21 correlates the pattern G23 with the geometric reference 221 by using the first and the second resolutions. For instance, the operation area 222 has a first image, and the first resolution is a resolution of the first image. According to the first and the second resolutions, dimensions of the pattern G23 are correlated with dimensions of the pattern G21, respectively, or correlated with dimensions of the geometric reference 221, respectively. In one embodiment, the pattern G23 and the operation area 222 have a first dimension and a second dimension corresponding to the first dimension, respectively; and the remote-control device 21 obtains a first scale relationship between the first and the second dimensions, and transforms the operation area 222 into the geometric reference GQ2 according to the first scale relationship and the pattern G23.

In one embodiment, the pattern G23 and the operation area 222 further have a third dimension independent of the first dimension and a fourth dimension, corresponding to the third dimension, independent of the second dimension, respectively; and the remote-control device 21 further obtains a second scale relationship between the third and the fourth dimensions, and transforms the operation area 222 into the geometric reference GQ2 according to the pattern G23 and the first and the second scale relationships.

In one embodiment, the remote-control device 21 includes a processing unit 21A, which includes an image-sensing unit 211, a motion-sensing unit 212, a communication interface unit 213 and a control unit 214. The image-sensing unit 211 has an image-sensing area 211K, and senses the pattern G21 to generate the signal S11 from the screen 22 through the image-sensing area 211K. The image-sensing unit 211 transmits the signal S11 to the control unit 214 to cause the control unit 214 to have the image Q21. The motion-sensing unit 212 generates a signal S21 in the reference direction U21, wherein the signal S21 may include sub-signals S211, S212 and S213.

The control unit 214 is coupled to the image-sensing unit 211, the motion-sensing unit 212 and the communication interface unit 213, receives the signal S11, arranges a geometric relationship R31 between the geometric reference Q211 and the image-sensing area 211K, obtains the geometric relationship R11 according to the signal S11, transforms the pattern G22 into the pattern G23 according to the geometric relationship R11, obtains the geometric reference GQ2 according to the pattern G23 to calibrate the geometric reference 221, and correlates the reference direction U21 with the predetermined position P21 according to the geometric reference GQ2 and the signal S21. The communication interface unit 213 is coupled to the control unit 214, wherein the control unit 214 controls the operation B1 of the screen 22 through the communication interface unit 213. For instance, the geometric references Q211 and GQ2 may be concentric or eccentric.

For instance, the remote-control device 21 is pointed to the predetermined position P21 to have the reference direction U21, and uses the control unit 214 to cause the cursor H21 to be located at the predetermined position P21 in the reference direction U21. For instance, the control unit 214 may further obtains a geometric relationship RA1 between the pattern G21 and the geometric reference 221, and obtains the geometric reference GQ2 according to the geometric relationship RA1 and the pattern G23.

For instance, the sub-patterns GA1, GB1, GC1 and GD1 of the pattern G21 are located near the four reference positions 221A, 221B, 221C and 221D of the geometric reference 221 (or the four corner points 22A, 22B, 22C and 22D of the operation area 222), respectively. The image-sensing unit 211 senses the sub-patterns GA1, GB1, GC1 and GD1 to generate the signal S11. The control unit 214 may directly define a perimeter 2221 (having a characteristic rectangle) and the corner points 22A, 22B, 22C and 22D of the operation area 222 through calculations. In one embodiment, the motion-sensing unit 212 includes a gyroscope 2121, an accelerometer 2122 and an electronic compass 2123. The signal S21 includes the sub-signals S211, S212 and S213. The gyroscope 2121 senses a speed of the remote-control device 21 in the reference direction U21 to generate the sub-signals S211. The accelerometer 2122 senses an acceleration and/or a pitch angle of the remote-control device 21 in the reference direction U21 to generate the sub-signals S212. The electronic compass 2123 senses a direction or an angular position of the remote-control device 21 in the reference direction U21 to generate the sub-signals S213.

In one embodiment, the control system 201 may further include a processing module 24. The processing module 24 is coupled to the remote-control device 21, the screen 22 and the marking device 23. The remote-control device 21 controls the processing module 24 to control the operation B1 of the screen 22. In the reference direction U21, the remote-control device 21 may instruct the processing module 24 to cause the cursor H21 to be located at the predetermined position P21. The processing module 24 controls the marking device 23 to display the pattern G21, and may control the pattern G21 to flicker at the specific frequency. For instance, the remote-control device 21 controls the processing module 24 to cause the marking device 23 to display the pattern G21. The processing module 24 may have a program and displays a digital content in the operation area 222 for displaying the pattern G21 by using the program. In one embodiment, the processing module 24 includes the marking device 23.

In one embodiment, a control method for calibrating a screen 22 is provided according to the illustration in FIG. 2, wherein the screen 22 has a geometric reference 221 for an operation B1. The control method includes the following steps. A pattern G21 associated with the geometric reference 221 is displayed on the screen 22. A remote-control device 21 is provided. A pattern G22 associated with the pattern G21 is generated, wherein the pattern G22 has a reference orientation NG22. The pattern G22 is transformed according to the reference orientation NG22 to obtain a geometric reference GQ2 for calibrating the geometric reference 221. Additionally, the remote-control device 21 is caused to control the operation B1 of the screen 22 based on the geometric reference GQ2.

In one embodiment, the pattern G22 has a shape center CN2 and a shape principal axis AX2. The reference orientation NG22 includes the shape center CN2 and a shape principal-axis direction FAX2, wherein the shape principal-axis direction FAX2 is a direction of the shape principal axis AX2. For instance, the remote-control device 21 may has a predetermined reference coordinate system, and the reference orientation NG22 refers to the predetermined reference coordinate system. For instance, the image-sensing area 211K of the image-sensing unit 211 has the predetermined reference coordinate system.

In one embodiment, the remote-control device 21 obtains a signal S11 from the screen 22. The signal S11 represents an image Q21 having a geometric reference Q221 and the pattern G22, wherein the geometric reference Q221 has a reference orientation NQ21. The remote-control device 21 transforms the pattern G22 into a pattern G23 according to a relationship RF1 between the reference orientation NG22 and the reference orientation NQ21, and defines the geometric reference 221 as a geometric reference GQ2 according to the pattern G23 for controlling the operation B1 of the screen 22.

For instance, the geometric reference Q211 has a shape center CN1 and a shape principal axis AX1. The reference orientation NQ21 includes the shape center CN1 and a shape principal-axis direction FAX1, wherein the shape principal-axis direction FAX1 is a direction of the shape principal axis AX1. For instance, the relationship RF1 between the reference orientation NG22 and the reference orientation NQ21 includes a position relationship between the shape center CN1 and the shape center CN2, and a direction relationship between the shape principal-axis direction FAX1 and the shape principal-axis direction FAX2. For instance, the control unit 214 of the remote-control device 21 obtains a transformation parameter PM1 according to the relationship RF1, and transforms the pattern G22 into the pattern G23 according to the transformation parameter PM1.

For instance, the transformation parameter PM1 is configured to correct a sensing error, which is derived from an alignment error between the remote-control device 21 and the screen 22. For instance, the pattern G23 has a reference orientation NG23, and the reference orientation NG23 includes the shape center CN3 and a shape principal-axis direction FAX3, wherein the shape principal-axis direction FAX3 is a direction of the shape principal axis AX3, and the shape principal-axis direction FAX3 is aligned with the shape principal-axis direction FAX1. For instance, each of the shape principal-axis directions FAX1, FAX2 and FAX3 is a respective geometric principal-axis direction.

In one embodiment, a remote-control device 21 for controlling an operation B1 of a screen 22 is provided according to the illustration in FIG. 2, wherein the screen 22 has a geometric reference 221 and a pattern G21 associated with the geometric reference 221. The remote-control device 21 includes a pattern generator 27 and a defining medium 28. The pattern generator 27 generates a pattern G22 associated with the pattern G21, wherein the pattern G22 has a reference orientation NG22. The defining medium 28 defines the geometric reference 221 according to the reference orientation NG22 for controlling the operation B1 of the screen 22. For instance, the pattern generator 27 is the image-sensing unit 211, and the defining medium 28 is the control unit 214. In one embodiment, the control unit 214 includes the pattern generator 27 and the defining medium 28, wherein the defining medium 28 is coupled to the pattern generator 27.

In one embodiment, the remote-control device 21 further includes a reference direction U21, a motion-sensing unit 212 and a communication interface unit 213. The pattern generator 27 has an image-sensing area 211K, and senses the pattern to generate a signal S11 from the screen 22 through the image-sensing area 211K in the reference direction U21, wherein the signal S11 represents an image Q21 including a geometric reference Q211 and the pattern G22. The motion-sensing unit 212 generates a signal S21 in the reference direction U21. The communication interface unit 213 is coupled to the defining medium 28 for controlling the operation B1.

In one embodiment, the geometric reference 221 identifies an operation area 222 on the screen 22. The operation area 222 has a cursor H21 and a predetermined position P21. The pattern G22 and the geometric reference Q211 have a geometric relationship R11 therebetween. The defining medium 28 is coupled to the communication interface unit 213, the pattern generator 27 and the motion-sensing unit 212, receives the signal S11, arranges a geometric relationship R31 between the geometric reference Q211 and the image-sensing area 211K, obtains the geometric relationship R11 according to the signal S11, transforms the pattern G22 into a pattern G23 according to the geometric relationship R11, obtains a geometric reference GQ2 according to the pattern G23 to define the geometric reference 221, and correlates the reference direction U21 with the predetermined position P21 according to the geometric relationship R11 and the signal S21.

In one embodiment, the defining medium 28 correlates the reference direction U21 with the predetermined position P21 according to the geometric relationship R11 and the estimated direction F21. The pattern G23 and the geometric reference Q211 have a geometric relationship R12 therebetween. The defining medium 28 obtains a geometric relationship RA1 between the pattern G21 and the geometric reference 211 for obtaining the geometric reference GQ2. The defining medium 28 causes the cursor H21 to be located at the predetermined position P21 in the reference direction U21. The geometric reference Q211 has a shape center CN1 and a shape principal axis AX1, the pattern G22 has a shape center CN1 and a shape principal axis AX2, and the pattern G23 has a shape center CN3 and a shape principal axis AX3. The geometric relationship R11 includes a position relationship between the shape center CN1 and the shape center CN2 and a direction relationship between the shape principal axis AX1 and the shape principal axis AX2. The shape principal axis AX2 has a direction FAX2, and the reference orientation NG22 includes the shape center CN2 and the direction FAX2.

In one embodiment, the remote-control device 21 obtains a transformation parameter PM1 according to the geometric relationship R11, and transforms the pattern G22 into the pattern G23 according to the transformation parameter PM1, wherein the transformation parameter PM1 includes a displacement parameter associated with the position relationship and a rotation parameter associated with the direction relationship. The geometric relationship R12 includes a first relationship and a second relationship, wherein the first relationship is that the shape center CN1 coincides with the shape center CN3, and the second relationship is that the shape principal axis AX1 is aligned with the shape principal axis AX3.

In one embodiment, the operation area 222 has a first resolution, the second geometric reference Q211 defines a first area having a second resolution provided by the image Q21, and the defining medium 28 uses the first and the second resolutions to correlate the pattern G23 with the geometric reference 221. The pattern G23 and the operation area 222 have a first dimension and a second dimension corresponding to the first dimension, respectively. The defining medium 28 obtains a scale relationship between the first and the second dimensions, and transforms the operation area 222 into the geometric reference GQ2 according to the scale relationship and the pattern G23.

In one embodiment, a control method for controlling an operation B1 of a screen 22 is provided according to the illustration in FIG. 2, wherein the screen 22 has a geometric reference 221. The control method includes the following steps. A pattern G21 associated with the geometric reference 221 is displayed on the screen 22. A remote-control device 21 is provided. A pattern G22 associated with the pattern G21 is generated, wherein the pattern G22 has a reference orientation NG22. Additionally, the geometric reference 221 is calibrated in the remote-control device 21 according to the reference orientation NG22 for controlling the operation B1 of the screen 22.

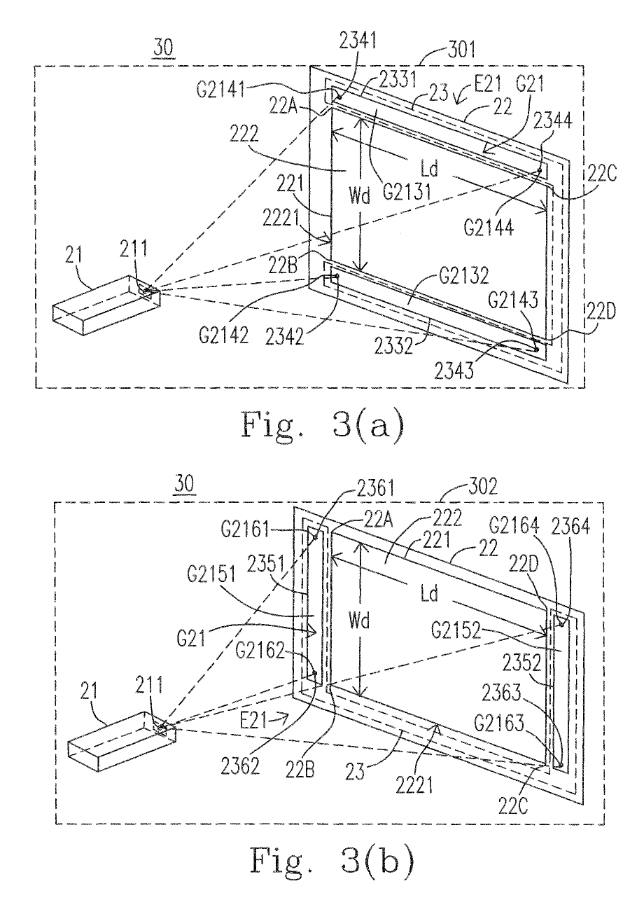

Please refer to FIG. 3(a), FIG. 3(b) and FIG. 3(c), which are schematic diagrams showing three configurations 301, 302 and 303 of a control system 30 according to the second embodiment of the present invention, respectively. As shown in FIG. 3(a), FIG. 3(b) and FIG. 3(c), each of the configurations 301, 302 and 303 includes a remote-control device 21, a screen 22 and a marking device 23. The marking device 23 displays a pattern G21 on the screen 22. The remote-control device 21 includes an image-sensing unit 211. For instance, the image-sensing unit 211 is a complementary metal-oxide semiconductor (CMOS) image sensor or a charge-coupled-device (CCD) image sensor.

The screen 22 has an operation area 222, which has a geometric reference 221; and the geometric reference 221 is configured to identify the operation area 222. The operation area 222 has a length Ld, a width Wd, and four corner points 22A, 22B, 22C and 22D. For instance, the operation area 222 is a display area, and may be located on the screen 22. The marking device 23 is coupled to the screen 22, and displays the pattern G21 associated with the corner points 22A, 22B, 22C and 22D on the screen 22.

In FIG. 3(a), the marking device 23 in the configuration 301 includes two light-bar generating units 2331 and 2332, and four light-spot generating units 2341, 2342, 2343 and 2344. The pattern G21 in the configuration 301 includes a characteristic rectangle E21, and two light bars G2131 and G2132 and four light spots G2141, G2142, G2143 and G2144 for defining the characteristic rectangle E21, wherein the two light bars G2131 and G2132 are configured to be auxiliary and horizontal. The light-bar generating units 2331 and 2332 and the light-spot generating units 2341, 2342, 2343 and 2344 generate the light bars G2131 and G2132 and the light spots G2141, G2142, G2143 and G2144, respectively. The light spots G2141 and G2144 are located in the light bar G2131, and the light spots G2142 and G2143 are located in the light bar G2132.

In FIG. 3(b), the marking device 23 in the configuration 302 includes two light-bar generating units 2351 and 2352, and four light-spot generating units 2361, 2362, 2363 and 2364. The pattern G21 in the configuration 302 includes a characteristic rectangle E21, and two light bars G2151 and G2152 and four light spots G2161, G2162, G2163 and G2164 for defining the characteristic rectangle E21, wherein the two light bars G2151 and G2152 are configured to be auxiliary and vertical. The light-bar generating units 2351 and 2352 and the light-spot generating units 2361, 2362, 2363 and 2364 generate the light bars G2151 and G2152 and the light spots G2161, G2162, G2163 and G2164, respectively. The light spots G2161 and G2162 are located in the light bar G2151, and the light spots G2163 and G2164 are located in the light bar G2152.

In FIG. 3(a) and FIG. 3(b), each of the plurality of light-bar generating units and the plurality of light-spot generating units is a respective external light-source device, and the plurality of light-bar generating units and the plurality of light-spot generating units are installed in the periphery of the operation area 222 in upper-lower symmetry or left-right symmetry about the operation area 222. The remote-control device 21 may be a motion-sensing remote controller or a 3D air mouse device. The pattern G21 is configured to indicate the perimeter 2221 and the corner points 22A, 22B, 22C and 22D of the operation area 222, and is configured to determine the absolute-coordinate position of the cursor moving in the operation area 222.

In FIG. 3(c), the marking device 23 in the configuration 303 includes a display device 237. For instance, the screen 22 is a surface portion of the display device 237. The marking device 23 plays a digital content, including the pattern G21, in the operation area 222, wherein the pattern G21 includes a characteristic rectangle E21, and four light spots G2171, G2172, G2173 and G2174 for defining the characteristic rectangle E21. For instance, the marking device 23 arranges the four light spots G2171, G2172, G2173 and G2174 to be played at the four corner points 22A, 22B, 22C and 22D, respectively. The abovementioned method includes employing the external light-source device or the digital content to play the light spots. In addition to operate the light spots with normal illumination, the light spots may be caused to flicker at a specific frequency for definitely distinguishing the light spots from the external noise or the background light (the background noise).

Additionally, the remote-control device 21 receives the light spots, processes the received light spots, obtains the geometric reference GQ2 by calculations, and utilizes the geometric reference GQ2 to define the coordinates of the four corner points 22A, 22B, 22C and 22D of the operation area 222 (or the four reference positions 221A, 221B, 221C and 221D of the geometric reference 221) for indicating the perimeter 2221 of the operation area 222 in the remote-control device 21, wherein the upper left corner point 22A, the lower left corner point 22B, the lower right corner point 22C and the upper right corner point 22D have coordinates A1(XL, YU), B1(XL, YD), C1(XR, YD) and D1(XR, YU), respectively. The four light spots in each of the configurations 301, 302 and 303 have a characteristic rectangle.

The image-sensing unit 211 of the remote-control device 21 has a pixel matrix unit (not shown), which has an image-sensing area 211K. The remote-control device 21 has a reference direction U21, and obtains the signal S11 representing the image Q21 of the screen 22 from the screen 22 through the image-sensing area 211K in the reference direction U21. The image Q21 in the pixel matrix unit has an image-sensing range Q212, a geometric reference Q211 and the pattern G22 associated with the pattern G21, wherein the image-sensing range Q212 represents the range of the image-sensing area 211K. For instance, the image-sensing area 211K may be a matrix sensing area, a pixel matrix sensing area or an image-sensor sensing area. The image-sensing unit 211 generates the signal S11 having the image Q21. The control unit 214 of the remote-control device 21 receives the signal S11, and processing the image Q21 according to the signal S11.

In one embodiment, the control unit 214 arranges a geometric relationship R41 between the geometric reference Q211 and the image-sensing range Q212. For instance, the geometric reference Q211 is configured to define the image-sensing range Q212. For instance, the geometric reference Q211 is configured to define a specific range Q2121 in the image-sensing range Q212. The specific range Q2121 and the image-sensing range Q212 have a specific geometric relationship therebetween, and the specific geometric relationship may include at least one selected from a group consisting of the same shape, the same shape center and the same shape principal-axis direction.

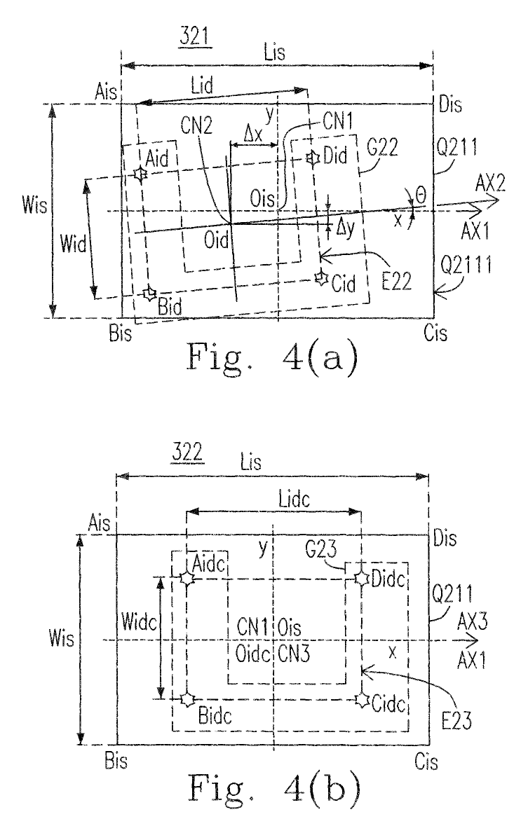

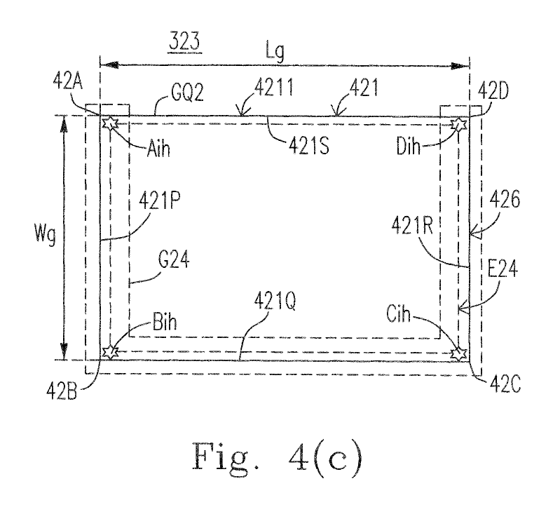

Please refer to FIG. 4(a), FIG. 4(b) and FIG. 4(c), which are schematic diagrams showing three pattern models 321, 322 and 323 of the control system 30 according to the second embodiment of the present invention, respectively. The control unit 214 of the control system 30 may obtain the pattern models 321, 322 and 323 according to the image Q21. As shown in FIG. 4(a), the pattern model 321 includes the geometric reference Q211 and the pattern G22 associated with the pattern G21. For instance, the geometric reference Q211 is configured to define the image-sensing range Q212. The geometric reference Q211 has a reference rectangle Q2111, which has an image-sensing length Lis, an image-sensing width Wis, an image-sensing area center point Ois (or the shape center CN1), a shape principal axis AX1 and four corner points Ais, Bis, Cis and Dis. For instance, the shape principal axis AX1 is aligned with the abscissa axis x. The pattern G22 has a characteristic rectangle E22, which has a characteristic rectangular area, wherein the characteristic rectangular area may be a pattern pick-up area or a pattern image pick-up display area.

The characteristic rectangle E22 has a pattern area length Lid, a pattern area width Wid, a pattern area center point Oid (or the shape center CN2), a shape principal axis AX2 and four corner points Aid, Bid, Cid and Did. The displacement from the image-sensing area center point Ois to the pattern area center point Oid has a component in a direction of the abscissa axis x, which is expressed as Δx. The displacement from the image-sensing area center point Ois to the pattern area center point Oid has a component in a direction of the ordinate axis y, which is expressed as Δy. The space from the abscissa (ordinate) axis (or the orientation or the shape principal axis AX1) of the geometric reference Q211 to the abscissa (or ordinate) axis (or the orientation or the shape principal axis AX2) of the pattern G22 has an angle θ. The control unit 214 obtains the geometric relationship R11 between the pattern G22 and the geometric reference Q211 by using the abovementioned analysis. The pattern G22 defines a first pattern area, and the geometric reference Q211 defines a second pattern area.

For instance, the remote-control device 21 employs a coordinate transformation to transform the pattern G22 into the pattern G23 for calibrating the screen 22. In FIG. 4(a), the image-sensing area center point Ois is the center point of the corner points Ais, Bis, Cis and Dis; and the pattern area center point Oid is the center point of the corner points Aid, Bid, Cid and Did. The control unit 214 of the remote-control device 21 causes the pattern area center point Oid to coincide with the image-sensing area center point Ois. In the state that the pattern area center point Oid has coincided with the image-sensing area center point Ois, the pattern G22 has a new center point Oidc.

Afterward, the new center point Oidc serves as a rotation center point, and the pattern G22 is rotated by an angle (−θ) of the angle θ around the new center point Oidc in the plane based on the abscissa and the ordinate axes of the geometric reference Q211. Therefore, the angle θ between the pattern G22 and the geometric reference Q211 will disappear due to the rotation, wherein the abscissa (or ordinate) axis or the orientation of the pattern G22 will coincide with that of the geometric reference Q211, or the abscissa (or ordinate) axis or the orientation of the first pattern area will coincide with that of the second pattern area. As shown in FIG. 4(b), the pattern model includes the geometric reference Q211 and the pattern G23.

The control unit 214 obtains a transformation parameter PM1 according to the geometric relationship R11, and transforms the pattern G22 into the pattern G23 according to the transformation parameter PM1, wherein the transformation parameter PM1 includes a displacement parameter and a rotation parameter. For instance, the displacement parameter includes the displacement Δx and the displacement Δy, and the rotation parameter includes the angle (−θ). For instance, the pattern G23 has a characteristic rectangle E23, which has a characteristic rectangular area. The characteristic rectangle E23 has a pattern area length Lidc, a pattern area width Widc, a pattern area center point Oidc (or the shape center CN3), a shape principal axis AX3 and four corner points Aidc, Bidc, Cidc and Didc, wherein there are the relationships of Lidc=Lid and Widc=Wid. In the pattern model 322, the pattern G23 and the geometric reference Q211 have a geometric relationship R12 therebetween.

The pattern G22 and the pattern G23 have the following relationships therebetween. The corner point Aid and the corner point Cid defines a straight line Aid_Cid, the corner point Bid and the corner point Did defines a straight line Bid_Did, and the straight line Aid_Cid crosses the straight line Bid_Did at an intersection point. The pattern area center point Oid may be obtained from the intersection point by solving the simultaneous equations of the straight line Aid_Cid and the straight line Bid_Did. The angle θ may be obtained from the formula

$$θ = {tan}^{- 1} \frac{V}{H} ,$$

wherein there are the relationships of V=y_Did-y_Aid and H=x_Did-x_Aid, y_Did represents the ordinate coordinate of the corner point Did, and x_Aid represents the abscissa coordinate of the corner point Aid. As shown in FIG. 4(a) and FIG. 4(b), the regular pattern G23 is completely located in the geometric reference Q211. The pattern G23 has the four corner points Aidc, Bidc, Cidc and Didc. A calculation formula is employed to translate the pattern G22 by the displacement Δx in the horizontal direction, translate the pattern G22 by the displacement Δy in the vertical direction, and rotate the pattern G22 by the angle θ for forming the pattern G23. The calculation formula has the form

$$( \begin{matrix}{x}^{′} \\ {y}^{′}\end{matrix} ) = ( \begin{matrix}cos θ & - sin θ \\ sin θ & cos θ\end{matrix} ) ( \begin{matrix}x \\ y\end{matrix} ) + ( \begin{matrix}Δ x \\ Δ y\end{matrix} ) ,$$

wherein x′: x_Aidc, x_Bidc, x_Cidc, x_Didc; y′: y_Aidc, y_Bidc, y_XCidc, y_Didc; x: x_Aid, x_Bid, x_Cid, x_Did; y′: y_Aid, y_Bid, y_XCid, y_Did; (x, y) represents the coordinate of any one selected from a group consisting of the corner points Aid, Bid, Cid and Did; and (x′, y′) represents the coordinate of any one selected from a group consisting of the corner points Aidc, Bidc, Cidc and Didc.

The pattern area length Lidc and the pattern area width Widc of the pattern G23 are equal to the pattern area length Lid and the pattern area width Wid of the pattern G22, respectively. The control unit 214 may utilize a length-scaling factor SL and a width-scaling factor SW to convert the pattern area length Lidc and the pattern area width Widc into an adjusted pattern area length and an adjusted pattern area width, respectively, so that the adjusted pattern area length and the adjusted pattern area width are consistent with the length Ld and the width Wd of the operation area 222, respectively. The length-scaling factor SL may has a relationship of SL=Ld/Lidc, and the width-scaling factor SW may has a relationship of SW=Wd/Widc; that is to say, Ld=Lidc×SL, and Wd=Widc×SW.

In the practical application, the control unit 214 may use the resolution of the operation area 222 and the resolution of the geometric reference Q211 to obtain the length-scaling factor SL and the width-scaling factor SW. The resolutions of the common image senor may have the following types: the CIF type has the resolution of 352×288 pixels being about 100,000 pixels; the VGA type has the resolution of 640×480 pixels being about 300,000 pixels; the SVGA type has the resolution of 800×600 pixels being about 480,000 pixels; the XGA type has the resolution of 1024×768 pixels being about 790,000 pixels; and the HD type has the resolution of 1280×960 pixels being about 1.2 M pixels. The resolutions of the common display device for the personal computer may have the following types: 800×600 pixels, 1024×600 pixels, 1024×768 pixels, 1280×768 pixels and 1280×800 pixels.

As shown in FIG. 4(c), the pattern model 323 includes a pattern G24 and the geometric reference GQ2, wherein the geometric reference GQ2 has a reference rectangle 426, and the reference rectangle 426 has four corner points 42A, 42B, 42C and 42D, which are configured to define the geometric reference 221 and the operation area 222. The control unit 214 converts the pattern G23 according to the length-scaling factor SL and the width-scaling factor SW to obtain the corner points 42A, 42B, 42C and 42D, wherein the corner points Aidc, Bidc, Cidc and Didc of the pattern G23 are converted into the corner points 42A, 42B, 42C and 42D, respectively, which are configured to define the four corner points 22A, 22B, 22C and 22D of the operation area 222, respectively. In one embodiment, the pattern G21 is converted into the pattern G22, and the pattern G22 is transformed into the corner points 42A, 42B, 42C and 42D by employing the image processing, the coordinate transformation and the scale transformation. The corner points 42A, 42B, 42C and 42D define a pattern area 421, which has a length Lg and a width Wg.

The control unit 214 stores the coordinates of the corner points 42A, 42B, 42C and 42D, and defines the pattern area 421 and a perimeter 4211 of the pattern area 421 according to the coordinates of the corner points 42A, 42B, 42C and 42D, wherein the perimeter 4211 includes four boundaries 421P, 421Q, 421R and 421S, and the length Lg and the width Wg of the pattern area 421 are equal to the length Ld and the width Wd of the operation area 222, respectively. In this way, the perimeter 4211 of the pattern area 421 and the perimeter 2221 of the operation area 222 may have a direct correspondence relationship of the same dimensions and the same orientations. The remote-control device 21 regards the coordinates of the corner points 42A, 42B, 42C and 42D as reference coordinates to start a cursor to move with a motion of the remote-control device 21.

In one embodiment, the pattern G21 and the corner points 22A, 22B, 22C and 22D of the operation area 222 have a first relationship thereamong, wherein the corner points 22A, 22B, 22C and 22D have the coordinates A1(XL, YU), B1(XL, YD), C1(XR, YD) and D1(XR, YU), respectively. For instance, the light spots G2171, G2172, G2173 and G2174 of the pattern G21 and the coordinates A1(XL, YU), B1(XL, YD), C1(XR, YD) and D1(XR, YU), respectively corresponding to the light spots G2171, G2172, G2173 and G2174, have a position relationship thereamong. The remote-control device 21 may obtain the position relationship and dimensions of the operation area 222 beforehand. According to the pattern model 322, the position relationship and the dimensions of the operation area 222, the remote-control device 21 may obtain a second relationship between the pattern G23 and the operation area 222, and transform the pattern G23 into the pattern G24. The pattern G24 has a characteristic rectangle E24, which has four corner points Aih, Bih, Cih and Dih. The remote-control device 21 obtains coordinates of the corner points Aih, Bih, Cih and Dih to define the corner points 42A, 42B, 42C and 42D of the geometric reference GQ2, respectively, and uses the corner points 42A, 42B, 42C and 42D to define the perimeter 2221 of the operation area 222 and respectively define the corner points 22A, 22B, 22C and 22D of the operation area 222. For instance, the geometric center of the characteristic rectangle E24 may be located at the image-sensing area center point Ois (or the shape center CN1).

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A control system for controlling an operation of a screen having a first geometric reference, the control system comprising:
a marking device displaying a first pattern associated with the first geometric reference on the screen; and
a remote-control device obtaining a first signal from the screen, wherein:
the first signal represents an image having a second geometric reference and a second pattern associated with the first pattern;
the second pattern and the second geometric reference have a first geometric relationship therebetween; and
the remote-control device uses the first geometric relationship to transform the second pattern into a third pattern, and calibrates the first geometric reference according to the third pattern for controlling the operation of the screen.

2. A control system according to claim 1, wherein:
the screen further has an operation area, wherein the operation area is a display area and has an upper left corner point, a lower left corner point, a lower right corner point and an upper right corner point;
the first geometric reference identifies the operation area and has a first reference rectangle, wherein the first reference rectangle has four reference positions located at the upper left corner point, the lower left corner point, the lower right corner point and the upper right corner point, respectively;
the second geometric reference is fixed and has a second reference rectangle;
the first pattern and the first geometric reference have a second geometric relationship therebetween, and the third pattern and the second geometric reference have a third geometric relationship therebetween; and
the remote-control device transforms the third pattern into a third geometric reference according to the second and the third geometric relationships for calibrating the first geometric reference.

3. A control system according to claim 2, wherein the marking device displays a digital content in the operation area for displaying the first pattern by using a program.

4. A control system according to claim 2, wherein:
the marking device includes four light-source devices; and
the first pattern flickers at a specific frequency and includes four sub-patterns, each of which is one of a light-emitting mark and a light-emitting spot, and the four sub-patterns are distributed near the four reference positions, respectively.

5. A control system according to claim 2, wherein the operation area has a first resolution, the second geometric reference defines a first area having a second resolution provided by the image, and the remote-control device correlates the third pattern with the first geometric reference by using the first and the second resolutions.

6. A control system according to claim 2, wherein:
the third pattern and the operation area have a first dimension and a second dimension corresponding to the first dimension, respectively; and
the remote-control device obtains a scale relationship between the first and the second dimensions, and transforms the operation area into the third geometric reference according to the scale relationship and the third pattern.

7. A control system according to claim 1, wherein:
the first geometric reference identifies an operation area on the screen;
the operation area includes a predetermined position; and
the remote-control device comprises:
a reference direction;
an image-sensing unit having an image-sensing area, and sensing the first pattern to generate the first signal from the screen through the image-sensing area in the reference direction;
a motion-sensing unit sensing the reference direction to generate a second signal;
a control unit coupled to the image-sensing and the motion-sensing units, receiving the first signal, arranging a second geometric relationship between the second geometric reference and the image-sensing area, obtaining the first geometric relationship according to the first signal, transforming the second pattern into the third pattern according to the first geometric relationship, obtaining a third geometric reference according to the third pattern to calibrate the first geometric reference, and correlating the reference direction with the predetermined position according to the third geometric reference and the second signal; and
a communication interface unit coupled to the control unit controlling the operation through the communication interface unit.

8. A control system according to claim 7, wherein:
the control unit further has a third geometric relationship between the first pattern and the first geometric reference for obtaining the third geometric reference;
the operation area has a cursor; and
the remote-control device causes the cursor to be located at the predetermined position by the control unit in the reference direction.

9. A control system according to claim 1, wherein:
the third pattern and the second geometric reference have a second geometric relationship therebetween;
the second geometric reference has a first shape center and a first shape principal axis, the second pattern has a second shape center and a second shape principal axis, and the third pattern has a third shape center and a third shape principal axis;
the first geometric relationship includes a position relationship between the first shape center and the second shape center and a direction relationship between the first shape principal axis and the second shape principal axis;
the remote-control device obtains a transformation parameter according to the first geometric relationship, and transforms the second pattern into the third pattern according to the transformation parameter, wherein the transformation parameter includes a displacement parameter associated with the position relationship and a rotation parameter associated with the direction relationship; and
the second geometric relationship includes a first relationship that the first shape center coincides with the third shape center, and a second relationship that the first shape principal axis is aligned with the third shape principal axis.

10. A control method for controlling an operation of a screen having a first geometric reference, the control method comprising steps of:
displaying a first pattern associated with the first geometric reference on the screen;
providing a remote-control device;
generating a second pattern associated with the first pattern, wherein the second pattern has a reference orientation; and
calibrating the first geometric reference in the remote-control device according to the reference orientation for controlling the operation of the screen.

11. A control method according to claim 10, wherein:
the remote-control device has a reference direction;
the first geometric reference identifies an operation area on the screen, wherein the operation area has a cursor and a predetermined position; and
the control method further comprises steps of:
obtaining a signal from the screen in the reference direction, wherein the signal represents an image including a second geometric reference and the second pattern, and the second pattern and the second geometric reference have a first geometric relationship therebetween;
transforming the second pattern into a third pattern according to the first geometric relationship, wherein the third pattern and the second geometric reference have a second geometric relationship therebetween;
obtaining a third geometric reference according to the third pattern to calibrate the first geometric reference;
obtaining an estimated direction for estimating the reference direction; and
correlating the reference direction with the predetermined position according to the first geometric relationship and the estimated direction.

12. A control method according to claim 11, wherein:
the second geometric reference has a first shape center and a first shape principal axis, the second pattern has a second shape center and a second shape principal axis, and the third pattern has a third shape center and a third shape principal axis;
the first geometric relationship includes a position relationship between the first shape center and the second shape center and a direction relationship between the first shape principal axis and the second shape principal axis;
the second shape principal axis has a first direction, and the reference orientation includes the second shape center and the first direction; and
the control method further comprises steps of:
obtaining a third geometric relationship between the first pattern and the first geometric reference for obtaining the third geometric reference;
causing the cursor to be located at the predetermined position in the reference direction; and
obtaining a transformation parameter according to the first geometric relationship, wherein:
the second pattern is transformed into the third pattern according to the transformation parameter;
the transformation parameter includes a displacement parameter associated with the position relationship and a rotation parameter associated with the direction relationship; and
the second geometric relationship includes a first relationship that the first shape center coincides with the third shape center, and a second relationship that the first shape principal axis is aligned with the third shape principal axis.

13. A control method according to claim 11, wherein:
the operation area has a first resolution;
the second geometric reference defines a first area having a second resolution provided by the image; and
the control method further comprises a step of correlating the third pattern with the first geometric reference according to the first and the second resolutions.

14. A control method according to claim 11, wherein the third pattern and the operation area have a first dimension and a second dimension corresponding to the first dimension, respectively, and the control method further comprises steps of:
obtaining a scale relationship between the first and the second dimensions; and
transforming the operation area into the third geometric reference according to the scale relationship and the third pattern.

15. A remote-control device for controlling an operation of a screen having a first geometric reference and a first pattern associated with the first geometric reference, the remote-control device comprising:
a pattern generator generating a second pattern associated with the first pattern, wherein the second pattern has a reference orientation; and
a defining medium defining the first geometric reference according to the reference orientation for controlling the operation of the screen.

16. A remote-control device according to claim 15, further comprising:
a reference direction, wherein the pattern generator has an image-sensing area, and senses the first pattern to generate a first signal from the screen through the image-sensing area in the reference direction, wherein the first signal represents an image including a second geometric reference and the second pattern;
a motion-sensing unit sensing the reference direction to generate a second signal; and
a communication interface unit coupled to the defining medium for controlling the operation.

17. A remote-control device according to claim 16, wherein:
the first geometric reference identifies an operation area on the screen;
the operation area has a cursor and a predetermined position;
the second pattern and the second geometric reference have a first geometric relationship therebetween; and
the defining medium is coupled to the pattern generator and the motion-sensing unit, receives the first signal, arranges a second geometric relationship between the second geometric reference and the image-sensing area, obtains the first geometric relationship according to the first signal, transforms the second pattern into a third pattern according to the first geometric relationship, obtains a third geometric reference according to the third pattern to define the first geometric reference, and correlates the reference direction with the predetermined position according to the first geometric relationship and the second signal.

18. A remote-control device according to claim 17, wherein:
the third pattern and the second geometric reference have a third geometric relationship therebetween;
the defining medium obtains a fourth geometric relationship between the first pattern and the first geometric reference for obtaining the third geometric reference;
the defining medium causes the cursor to be located at the predetermined position in the reference direction;
the second geometric reference has a first shape center and a first shape principal axis, the second pattern has a second shape center and a second shape principal axis, and the third pattern has a third shape center and a third shape principal axis;
the first geometric relationship includes a position relationship between the first shape center and the second shape center and a direction relationship between the first shape principal axis and the second shape principal axis;
the second shape principal axis has a first direction, and the reference orientation includes the second shape center and the first direction;
the remote-control device obtains a transformation parameter according to the first geometric relationship, and transforms the second pattern into the third pattern according to the transformation parameter, wherein the transformation parameter includes a displacement parameter associated with the position relationship and a rotation parameter associated with the direction relationship; and
the third geometric relationship includes a first relationship that the first shape center coincides with the third shape center, and a second relationship that the first shape principal axis is aligned with the third shape principal axis.

19. A remote-control device according to claim 17, wherein the operation area has a first resolution, the second geometric reference defines a first area having a second resolution provided by the image, and the defining medium correlates the third pattern with the first geometric reference by using the first and the second resolutions.

20. A remote-control device according to claim 17, wherein:
the third pattern and the operation area have a first dimension and a second dimension corresponding to the first dimension, respectively; and
the defining medium obtains a scale relationship between the first and the second dimensions, and transforms the operation area into the third geometric reference according to the scale relationship and the third pattern.
